(19) United States
(12) Patent Application Publication
(10) Pub. No.: US 2005/0033499 A1
(43) Pub. Date: Feb. 10, 2005

(54) Method and a computer readable storage device for estimating tire-to-road friction

(76) Inventors: Jonas Ekmark, Olofstorp (SE); Jonas Jansson, Linkoping (SE)

Correspondence Address: FORD GLOBAL TECHNOLOGIES, LLC., SUITE 600 - PARKLANE TOWERS EAST, ONE PARKLANE BLVD., DEARBORN, MI, 48126, US

(21) Appl. No.: 10/858,896

(22) Filed: May 27, 2004

(30) Foreign Application Priority Data
May 28, 2003 (EP) 03076634.9

(51) Int. Cl. G06F 17/00

(52) U.S. Cl. 701/80; 73/105

(57) ABSTRACT

The invention relates to a method for estimating road-to-tire friction between tires of a wheeled vehicle and a road surface, which vehicle is provided with a collision avoidance system. The method includes the steps of applying a positive torque to both wheels on a first axle and an equal and opposite negative torque to at least one wheel on a second axle. The method further includes measuring current values for vehicle speed, angular acceleration of the wheel on the second axle and the negative torque applied to said wheel. The method also includes determining a current friction coefficient using a friction coefficient determining device. The invention further relates to an apparatus for using the method.

### FIELD OF THE INVENTION

The invention relates to a method for estimating the road-to-tire friction in order for a collision avoidance system to adapt to current road friction conditions.

### DESCRIPTION OF THE RELATED ART

Tire-to-road friction can be estimated by observing longitudinal stiffness, as described in SAE paper 2001-01-0796. The problem of estimating the tire to road friction is that for low excitation levels, such as low throttling or braking levels, the estimate becomes less reliable.

Collision avoidance systems—including systems for collision mitigation and collision warning—continuously estimate the risk of having a collision, as described in SAE papers 2001-01-0357 and 2002-01-0403. This can be done by using various sensors, such as radar, lidar and other vision systems to observe objects in front of the host vehicle. A collision avoidance system intervenes when the collision risk exceeds a certain threshold. In practice, the opportunity to intervene is greatly affected by the available tire-to-road friction.

JP-A-07-132 787 discloses a method for estimating tire-to-road friction in which a road friction factor is determined as an automatic braking process decelerates the vehicle. This solution requires a relatively high-speed processor since the collision-preventing device is active, or braking, as the road friction factor is being estimated. Since this arrangement only uses the brakes it is only useful when the vehicle is decelerating. Moreover, an unexpected automatic actuation of the brakes may significantly disturb the driver.

A problem to be solved by this invention is to provide a means for estimating friction upon the collision avoidance system's demand. This will improve the performance of the collision avoidance system in low friction situations while retaining a low sensitivity to false warnings in high friction surroundings. The invention provides a means of estimating tire-to-road friction upon demand without disturbing the driver.

### SUMMARY OF THE INVENTION

Against this background, a means for performing a friction estimate upon demand from the decision mechanism of a collision avoidance system that will improve the performance of the collision avoidance system in low friction situations while retaining a low sensitivity to false warnings in high friction surroundings is possible.

The present invention is a method for estimating road-to-tire friction between the tires of a wheeled vehicle and a road surface for use on a vehicle with a collision avoidance system. The method involves applying a positive torque to both wheels on a first axle and an equal and opposite negative torque to at least one wheel on a second axle. Furthermore, measurements are taken of the vehicle's speed, angular acceleration of the wheel on the second axle, and the negative torque applied to the wheel. Additionally, a current friction coefficient is determined using a friction coefficient determining means.

According to a preferred embodiment of the invention the positive torque may be applied by means of a propulsion unit connected to the first axle through a drivetrain for driving one or more wheels on the first axle. The negative torque may be applied by actuating braking means for at least one wheel on the second axle. The negative torque may also be applied by offsetting a rotational ratio between the first and second axle by an equal and opposite amount. An adjustable all-wheel-drive (AWD) coupling may be used for the purpose of applying positive and negative torque.

The computer readable storage device comprises instructions for initiating a procedure for estimating of road-to-tire friction upon request from the collision avoidance system and instructions for application of a positive driving torque to both wheels on a first axle. The storage device further includes instructions for simultaneous application of an equal and opposite negative braking torque to at least one wheel on a second axle; instructions for determining a value for a current friction coefficient (μ) using a friction coefficient determining means, and instructions for transmitting the value for a current friction coefficient (μ) to the collision avoidance system. By using a friction estimate in the decision mechanism of a collision avoidance system, its performance can be improved in low-friction conditions, while retaining its immunity to false warnings in high-friction conditions.

### BRIEF DESCRIPTION OF THE DRAWINGS

In the following text, the invention will be described in detail with reference to the figures, in which:

FIG. 1 shows a schematic illustration of a vehicle provided with means for estimating road-to-tire friction according to a first embodiment of the invention;

FIG. 2 shows a schematic illustration of a vehicle provided with means for estimating road-to-tire friction according to a second embodiment of the invention;

FIG. 3 shows a flow chart illustrating the procedure for determining the road-to-tire friction coefficient.

### DETAILED DESCRIPTION OF THE PREFERRED EMBODIMENTS

The present invention will be explained in the figures using the example of collision avoidance systems. However, the invention is not restricted to this use and may in principle also be used in the application of similar control systems.

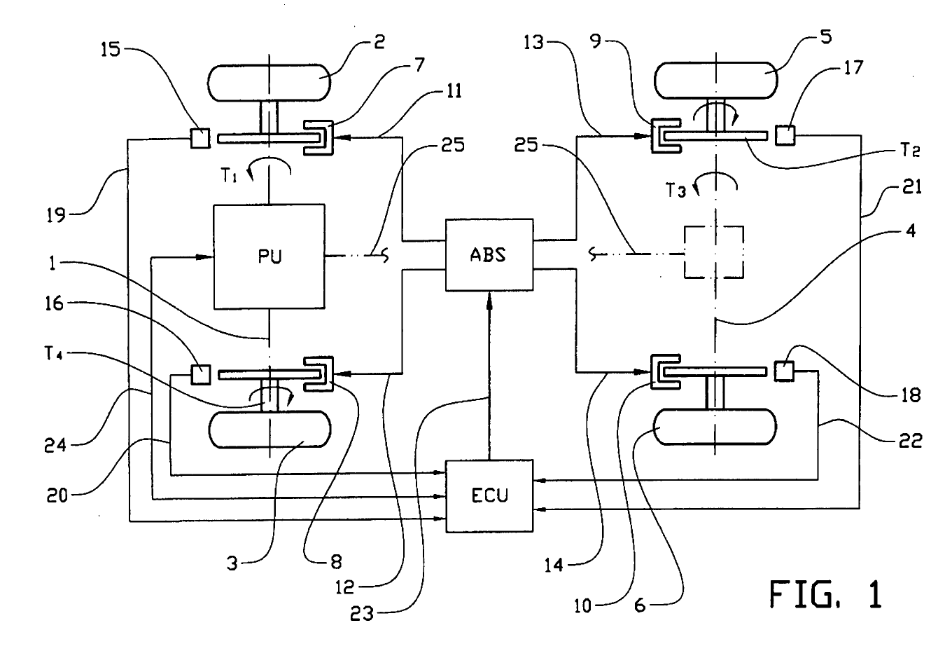

FIG. 1 shows a schematic illustration of a vehicle having a front axle 1 and two front wheels 2, 3, and a rear axle 4 and two rear wheels 5, 6. Each wheel is provided with a brake actuator 7-10 supplied with hydraulic pressure from a hydraulic block of a main brake cylinder (not shown). The brake actuators 7-10 are individually controlled by an anti-locking brake control unit ABS that transmits control signals to the brake actuators through signal lines 11-14. An electronic control unit ECU also receives signals representing the hydraulic pressure in each actuator 7-10 from a number of pressure sensors (not shown). Each wheel is also provided with speed sensors 15-18 which transmit signals representing the speed of each wheel 2, 3, 5, 6 to the electronic control unit ECU through signal lines 19-22. The electronic control unit ECU is connected to the anti-locking brake control unit (ABS) through a signal line 23 allowing the electronic control unit to control individual brake actuators. The electronic control unit (ECU) is further connected to a control unit (not shown) for a propulsion unit PU through a signal line 24, allowing the ECU to receive and transmit signals for controlling the torque output of the propulsion unit PU. The signals received may include a torque signal and/or an engine speed and an instantaneous crankshaft acceleration signal allowing the torque output to be calculated.

If the propulsion unit is an internal combustion engine, the ECU will control a throttle or similar device to adjust the torque output of the engine.

The ECU contains an evaluation circuit for calculating an estimated value of the tire-to-road friction coefficient (μ) which is based on the signals received from the aforementioned sensors.

The vehicle is provided with a collision avoidance system that can determine when to perform an automatic excitation of the tire-to-road contact surfaces in order to estimate the maximum available tire-to-road friction coefficient, μ. The automatic excitation is performed when the collision risk estimated by the collision avoidance system exceeds a predetermined limit value. This limit value is lower than the threshold value or values, which will actually trigger a collision avoidance system intervention. The estimated friction coefficient can then be used to influence the decision mechanisms of the collision avoidance system.

The arrangement in FIG. 1 operates as follows. When the collision risk estimated by the collision avoidance system exceeds a predetermined limit value, a signal is transmitted to the electronic control unit to perform an automatic excitation of the tire-to-road contact surfaces to estimate the maximum available tire-to-road friction coefficient, μ.

The electronic control unit transmits a signal to the anti-locking brake control unit to actuate one of the brake actuators 9, 10 on the rear axle. Simultaneously, a signal is transmitted to the control unit for the propulsion unit PU, in order to increase the torque output T₁ of the propulsion unit PU. The electronic control unit will then monitor the braking force applied to one rear wheel and balance the braking torque T₂ with a corresponding torque T₁ increase from the propulsion unit PU to both the front wheels 2, 3. In this way the driver of the vehicle will not experience a change in vehicle speed or an unexpected acceleration caused by the application of the brakes while the procedure for estimating the maximum available tire-to-road friction coefficient, μ, is performed.

FIG. 1 also indicates, a drive shaft 25 from the propulsion unit PU to the rear axle 4, as would be the case for a rear wheel drive vehicle. In this case the electronic control unit transmits a signal to the anti-locking brake control unit (ABS) to actuate one of the brake actuators 7, 8 on the front axle. Simultaneously a signal is transmitted to the control unit for the propulsion unit PU, in order to increase the torque output T₃ of the propulsion unit PU to the rear axle 4. The electronic control unit will then monitor the braking force applied to the one front wheel and balance the braking torque T₄ with a corresponding torque T₃ increase from the propulsion unit PU to both the rear wheels 5, 6.

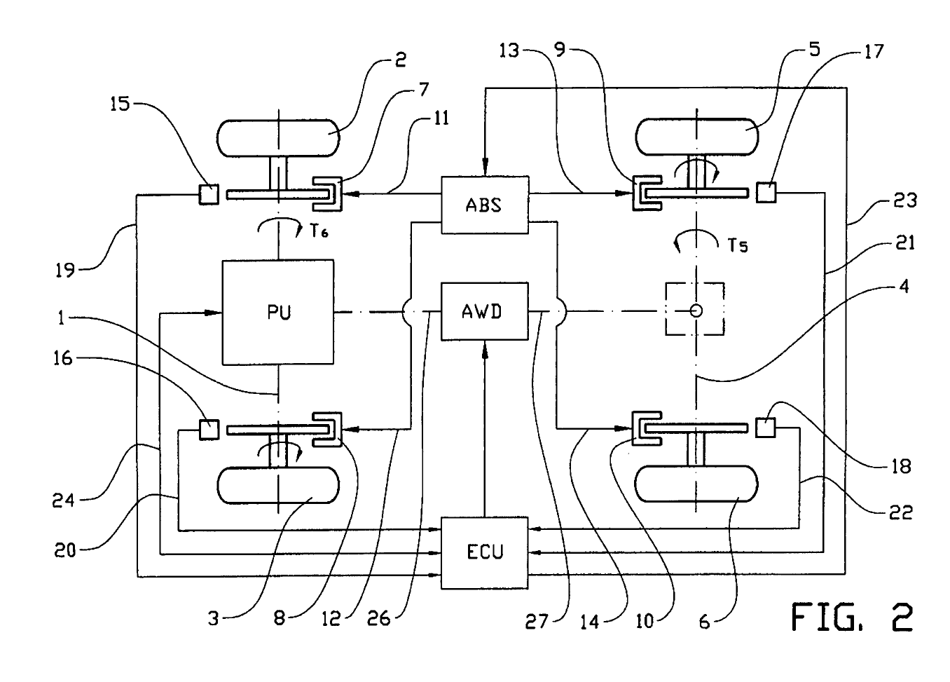

FIG. 2 shows, a schematic illustration of a vehicle substantially as described in connection with FIG. 1. The main difference between the embodiments is that the vehicle shown in FIG. 2 is provided with an all-wheel-drive coupling (AWD) between the front and rear axles 1, 4. The propulsion unit PU drives the front wheels 2, 3 through the front axle 1 and the rear wheels 5, 6 through a drivetrain comprising a first drive shaft 26, an all-wheel-drive coupling AWD, a second drive shaft 27 and the rear axle 4. The all-wheel-drive coupling distributes the torque output from the propulsion unit PU so that the front axle 1 receives 70% and the rear axle 4 receives 30% of the available torque.

The arrangement in FIG. 2 operates as follows. When the collision risk estimated by the collision avoidance requires an automatic excitation of the tire-to-road contact surfaces to be performed, in order to estimate the maximum available tire-to-road friction coefficient μ, a signal is transmitted to the electronic control unit.

The electronic control unit transmits a signal to the all-wheel-drive coupling to perform a redistribution of the torque. A positive, driving torque T₅ is supplied to the rear axle 4 at the same time as a negative braking torque T₆ is applied to the front axle 1. In this way, the positive and the negative torque T₅ and T₆ respectively is applied by offsetting the rotational ratio between the front and rear axles by an equal and opposite amount. This will virtually cancel the acceleration effect on the vehicle as a whole but causes the contact surfaces of the wheels on both axles to be excited. A relatively quick friction estimation can then be performed by the evaluation circuit in the electronic control unit, before the torque distribution returns to the normal setting.

In a vehicle with a normally fixed rotational ratio between front and rear axles, the torque is typically distributed so that the front wheels have more tractive power under normal conditions. Normal conditions may be defined as a relatively constant speed on a dry, flat surface, such as tarmac. The front/rear distribution of the total torque supplied to the drivetrain by a propulsion unit, such as an internal combustion engine or an electric motor, may for instance be 70/30. By increasing the torque level of the AWD coupling, the resulting torque would appear with opposite signs at the front and rear axles, thus virtually cancelling the acceleration effect on the vehicle as a whole, but still exciting the contact surfaces of the wheels on both axles to enable a relatively quick and precise friction estimation in a potentially dangerous situation.

In this invention, the offset of the rotational ratio between the axles may be 2-5%, preferably 3%. Hence one axle may receive 3% more torque, while the other axle receives 3% less torque, compared to the normal 70/30% torque distribution.

In the preferred embodiment the rotational ratio between the axles is set up to include a certain offset, e.g. 3% higher angular velocity at the rear axle. However, it is of course possible to reverse the torque distribution, so that the front axle receives a higher angular velocity.

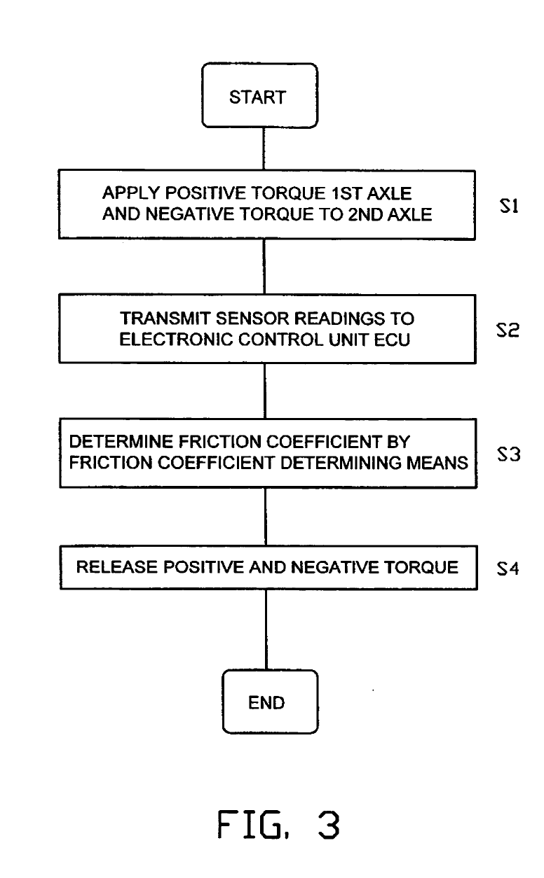

FIG. 3 shows, a flow chart illustrating the procedure for determining the road-to-tire friction coefficient. The procedure is initiated when a collision risk estimated by the collision avoidance system exceeds a predetermined limit value. This limit value is lower than the threshold value or values, which will actually trigger a collision avoidance intervention or collision warning. In a first step S1 the electronic control unit (ECU) simultaneously applies a positive, driving torque to one axle of the vehicle and an equal and opposite negative braking torque to a second axle of the vehicle. The application of positive and negative torque is balanced so that the acceleration effect on the vehicle is cancelled. In a second step S2 sensor readings from vehicle speed sensors, angular acceleration sensors for the wheels, and sensors measuring values representing the negative torque are transmitted to the electronic control unit ECU. In a third step S3 a friction determining means, such as an evaluation circuit determines an estimated road-to-tire friction coefficient, μ. The evaluation circuit can be a separate unit or be integrated in the electronic control unit. In a fourth step S4 the ECU releases the torque control and the estimated road-to-tire friction coefficient is transmitted to the collision avoidance system. The estimated friction coefficient can then be used to influence the decision mechanisms of the collision avoidance system.

The embodiment of FIG. 2 can also be provided with the sensor and control arrangements as described in connection with FIG. 1, as indicated. This can be used to provide the electronic control unit ECU with feedback signals allowing the actual offset of the torque distribution to be monitored.

Alternatively, the arrangement can also be used as described in connection with FIG. 1, when the four-wheel drive has been disengaged. The vehicle may then use either front or rear wheel drive. The all-wheel-drive coupling AWD may also allow switching between the two drive modes.

Although the above arrangements are described for a vehicle with an internal combustion engine and a hydraulic brake system, the inventive idea may also be applied to electrically propelled vehicles with two or four wheel drive and electrically actuated brakes.

The invention is not limited to the embodiments described above and may be varied freely within the scope of the appended claims.

1. A method for estimating road-to-tire friction between tires of a wheeled vehicle having a collision avoidance system and a road surface comprising the steps of:
applying a positive torque to both wheels on a first axle and an equal and opposite negative torque to at least one wheel on a second axle;
measuring current values for vehicle speed, angular acceleration of the wheel on the second axle and the negative torque applied to the wheel; and
determining a current friction coefficient using a friction coefficient determining means.

2. A method according to claim 1, wherein the step of applying the positive torque is performed by means of a propulsion unit connected to the first axle through a drivetrain for driving one or more wheels on the first axle.

3. A method according to claim 1, wherein the step of applying the negative torque further includes the step of actuating a brake for said at least one wheel.

4. A method according to claim 1, wherein the step of applying the positive and the negative torque further includes the step of offsetting a rotational ratio between the first and second axle by an equal and opposite amount.

5. A method according to claim 4, wherein the step of offsetting the rotational ratio of the axles further includes the step of controlling output torque levels of an all wheel drive coupling connected to the first and second axles.

6. A method according to claim 4, further including offsetting the rotational ratio of the axles so that the rearward of the first and second axles has a higher angular velocity.

7. A method according to claim 6, further including offsetting the rotational ratio between the axles by 2-5%.

8. A method according to claim 6, further including offsetting the rotational ratio between the axles by 3%.

9. A method according to claim 1, further including the step of estimating a current tire-to-road friction value and activating the collision avoidance system when the tire-to-road friction value is lower than a threshold value.

10. A computer readable storage device having stored therein data representing instructions executable by a computer to perform an estimate of road-to-tire friction between tires of a wheeled vehicle and a road surface on request from a collision avoidance system, the vehicle having at least two axles, means for applying a positive driving torque to both wheels on a first axle, means for applying an equal and opposite negative braking torque to at least one wheel on a second axle, an electronic control unit (ECU) for controlling the application of torque, and a friction coefficient determining means for determining an estimated value of a road-to-tire friction coefficient (μ), the computer readable storage device comprising:
instructions for initiating a procedure for estimating road-to-tire friction upon request from the collision avoidance system;
instructions for application of a positive, driving torque to both wheels on the first axle;
instructions for simultaneous application of an equal and opposite negative braking torque to at least one wheel on the second axle;
instructions for determining a value for a current friction coefficient (μ) using the friction coefficient determining means; and
instructions for transmitting the value for a current friction coefficient (μ) to the collision avoidance system.

11. An apparatus for estimating road-to-tire friction between tires of a wheeled vehicle having a collision avoidance system and a road surface comprising:
means for applying a positive torque to both wheels on a first axle and an equal and opposite negative torque to at least one wheel on a second axle;
means for measuring vehicle speed, angular acceleration of the wheel on the second axle and the negative torque applied to the wheel; and
means for determining a current friction coefficient.

12. An apparatus according to claim 11, further including a propulsion unit connected to the first axle through a drivetrain for driving one or more wheels on the first axle.

13. An apparatus according to claim 11, wherein said means for applying the negative torque further includes means for actuating a brake for said at least one wheel.

14. An apparatus according to claim 11, wherein said means for applying the positive and the negative torque further includes means for offsetting a rotational ratio between the first and second axle by an equal and opposite amount.

15. An apparatus according to claim 14, wherein said means for offsetting the rotational ratio of the axles further includes means for controlling output torque levels of an all wheel drive coupling connected to the first and second axles.

16. An apparatus according to claim 14, wherein the rotational ratio of the rearward of the first and second axles has a higher angular velocity than the other axle.

17. An apparatus according to claim 16, wherein the rotational ratio between the axles is offset by 2-5%.

18. An apparatus according to claim 16, wherein the rotational ratio between the axles is offset by 3%.

19. An apparatus according to claim 11, further including means for estimating a current tire-to-road friction value such that said collision avoidance system is actuated when the tire-to-road friction value is lower than a threshold value.
